(19) United States
(12) Patent Application Publication
(10) Pub. No.: US 2014/0123679 A1
(43) Pub. Date: May 8, 2014

(54) FLEXIBLE HEAT SHIELD FOR A GAS TURBINE ENGINE

(71) Applicant: UNITED TECHNOLOGIES CORPORATION, Hartford, CT (US)

(72) Inventors: Raphael Lior, Brookline, MA (US); Matthew J. Howlett, North Haven, CT (US)

(73) Assignee: UNITED TECHNOLOGIES CORPORATION, Hartford, CT (US)

(21) Appl. No.: 13/671,075

(22) Filed: Nov. 7, 2012

(51) Int. Cl. F02C 7/24

(52) U.S. Cl. CPC F02C 7/24
USPC 60/801

(57) ABSTRACT

A flexible heat shield for a gas turbine engine includes a support layer attached to a ceramic fiber layer.

### BACKGROUND

The present disclosure relates to a gas turbine engine and, more particularly, to a heat shield therefor.

Gas turbine engines, such as those that power modern commercial and military aircraft, generally include a compressor section to pressurize an airflow, a combustor section for burning a hydrocarbon fuel in the presence of the pressurized air, and a turbine section to extract energy from the resultant combustion gases. An engine case structure formed of multiple cases or modules to facilitate assembly surround these sections. The engine cases may be subject to a relatively harsh environment as the products of combustion at high temperature pass through.

Accessory components are mounted to the engine case structure or other components on the engine with an intermediate heat shield to shield the external components from convection and radiation that lead to high temperatures. These metal heat shields are specifically formed, relatively bulky, heavy, require other attachment components such as brackets, and self-emit radiation to the accessory components they shield.

### SUMMARY

A flexible heat shield according to one disclosed non-limiting embodiment of the present disclosure includes a ceramic fiber layer and a support layer attached to said ceramic fiber layer.

In a further embodiment of the foregoing embodiment, the ceramic fiber layer includes aluminum oxide, silicon oxide, or bromine oxide.

In a further embodiment of any of the foregoing embodiments, the support layer is a wire mesh.

In a further embodiment of any of the foregoing embodiments, the support layer is a sheet metal.

In a further embodiment of any of the foregoing embodiments, the ceramic fiber layer and said support layer include a multiple of metal grommets.

In a further embodiment of any of the foregoing embodiments, the flexible heat shield includes a multiple of grommets which attach said ceramic fiber layer and said support layer together. In the alternative or additionally thereto, the foregoing embodiment includes a multiple of ceramic fiber layers. In the alternative or additionally thereto, the foregoing embodiment includes a multiple of ceramic fiber layers which sandwich said support layer therebetween. In the alternative or additionally thereto, in the foregoing embodiment the ceramic fiber layer is folded over the support layer therebetween.

A gas turbine engine according to another disclosed non-limiting embodiment of the present disclosure includes an engine case and a flexible heat shield mounted to said engine case.

In a further embodiment of the foregoing embodiment, the gas turbine engine includes a multiple of bosses which extend from said engine case, said flexible heat shield mounted to said multiple of bosses. In the alternative or additionally thereto, in the foregoing embodiment each of the multiple of bosses define an X, Y, Z location for said flexible heat shield. In the alternative or additionally thereto, the foregoing embodiment includes a multiple of metal grommets which attach said flexible heat shield to said multiple of bosses. In the alternative or additionally thereto, the foregoing embodiment includes a fastener that extends through each of said metal grommets and into a respective one of said multiple of bosses. In the alternative or additionally thereto, in the foregoing embodiment includes the multiple of bosses are J-Blades.

In a further embodiment of any of the foregoing embodiments, the flexible heat shield includes a ceramic fiber layer, and a support layer attached to the ceramic fiber layer. In the alternative or additionally thereto, the foregoing embodiment includes a multiple of grommets which attach the ceramic fiber layer and said support layer together. In the alternative or additionally thereto, the foregoing embodiment includes a multiple of ceramic fiber layers. In the alternative or additionally thereto, the foregoing embodiment includes a multiple of ceramic fiber layers which sandwich said support layer therebetween. In the alternative or additionally thereto, in the foregoing embodiment the ceramic fiber layer is folded over said support layer therebetween.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-section of a gas turbine engine;

FIG. 2 is a schematic view of a gas turbine engine case structure;

FIG. 3 is an expanded perspective view of an external component mounted to a diffuser case with a flexible heat shield therebetween;

FIG. 4 is an exploded perspective view of a flexible heat shield according to one disclosed non-limiting embodiment;

FIG. 5 is an exploded side view of a flexible heat shield according to another disclosed non-limiting embodiment; and

FIG. 6 is an end view of an external component mounted to a diffuser case with a flexible heat shield therebetween.

### DETAILED DESCRIPTION

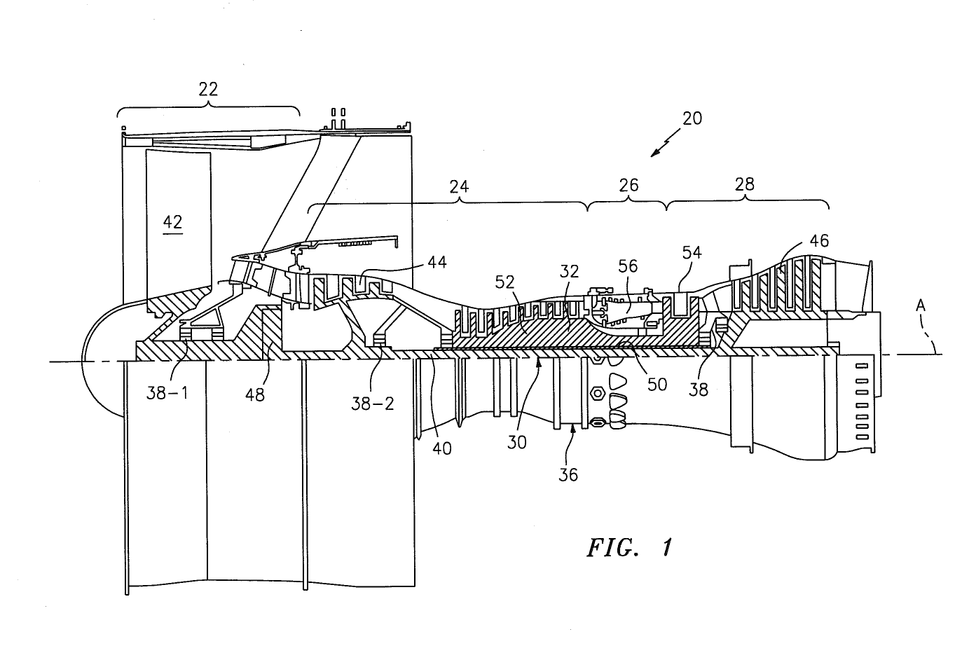

FIG. 1 schematically illustrates a gas turbine engine 20. The gas turbine engine 20 is disclosed herein as a two-spool turbo fan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan in the disclosed non-limiting embodiment, it should be understood that the concepts described herein are not limited to use with turbofans as the teachings may be applied to other types of turbine engines such as a turbojets, turboshafts, and three-spool (plus fan) turbofans wherein an intermediate spool includes an intermediate pressure compressor (“IPC”) between a Low Pressure Compressor (“LPC”) and a High Pressure Compressor (“HPC”), and an intermediate pressure turbine (“IPT”) between the high pressure turbine (“HPT”) and the Low pressure Turbine (“LPT”).

The engine 20 generally includes a low spool 30 and a high spool 32 mounted for rotation about an engine central longitudinal axis A relative to an engine case assembly 36 via several bearing structures 38. The low spool 30 generally includes an inner shaft 40 that interconnects a fan 42, a low pressure compressor 44 (“LPC”) and a low pressure turbine 46 (“LPT”). The inner shaft 40 drives the fan 42 directly or through a geared architecture 48 to drive the fan 42 at a lower speed than the low spool 30. An exemplary reduction transmission is an epicyclic transmission, namely a planetary or star gear system.

The high spool 32 includes an outer shaft 50 that interconnects a high pressure compressor 52 (“HPC”) and high pressure turbine 54 (“HPT”). A combustor 56 is arranged between the high pressure compressor 52 and the high pressure turbine 54. The inner shaft 40 and the outer shaft 50 are concentric and rotate about the engine central longitudinal axis A which is collinear with their longitudinal axes.

Core airflow is compressed by the LPC 44 then the HPC 52, mixed with the fuel and burned in the combustor 56, then expanded over the HPT 54 and the LPT 46. The turbines 54, 46 rotationally drive the respective low spool 30 and high spool 32 in response to the expansion. The main engine shafts 40, 50 are supported at a plurality of points by bearing structures 38 within the case assembly 36. It should be understood that various bearing structures 38 at various locations may alternatively or additionally be provided.

In one non-limiting example, the gas turbine engine 20 is a high-bypass geared aircraft engine. In a further example, the gas turbine engine 20 bypass ratio is greater than about six (6:1). The geared architecture 48 can include an epicyclic gear train, such as a planetary gear system or other gear system. The example epicyclic gear train has a gear reduction ratio of greater than about 2.3, and in another example is greater than about 2.5:1. The geared turbofan enables operation of the low spool 30 at higher speeds which can increase the operational efficiency of the low pressure compressor 44 and low pressure turbine 46 and render increased pressure in a fewer number of stages.

A pressure ratio associated with the low pressure turbine 46 is pressure measured prior to the inlet of the low pressure turbine 46 as related to the pressure at the outlet of the low pressure turbine 46 prior to an exhaust nozzle of the gas turbine engine 20. In one non-limiting embodiment, the bypass ratio of the gas turbine engine 20 is greater than about ten (10:1), the fan diameter is significantly larger than that of the low pressure compressor 44, and the low pressure turbine 46 has a pressure ratio that is greater than about five (5:1). It should be understood, however, that the above parameters are only exemplary of one embodiment of a geared architecture engine and that the present disclosure is applicable to other gas turbine engines including direct drive turbofans.

In one embodiment, a significant amount of thrust is provided by the bypass flow path B due to the high bypass ratio. The fan section 22 of the gas turbine engine 20 is designed for a particular flight condition—typically cruise at about 0.8 Mach and about 35,000 feet. This flight condition, with the gas turbine engine 20 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example gas turbine engine 20 is less than 1.45. Low Corrected Fan Tip Speed is the actual fan tip speed divided by an industry standard temperature correction of (“T”/518.7^{0.5}) in which “T” represents the ambient temperature in degrees Rankine. The Low Corrected Fan Tip Speed according to one non-limiting embodiment of the example gas turbine engine 20 is less than about 1150 fps (351 m/s).

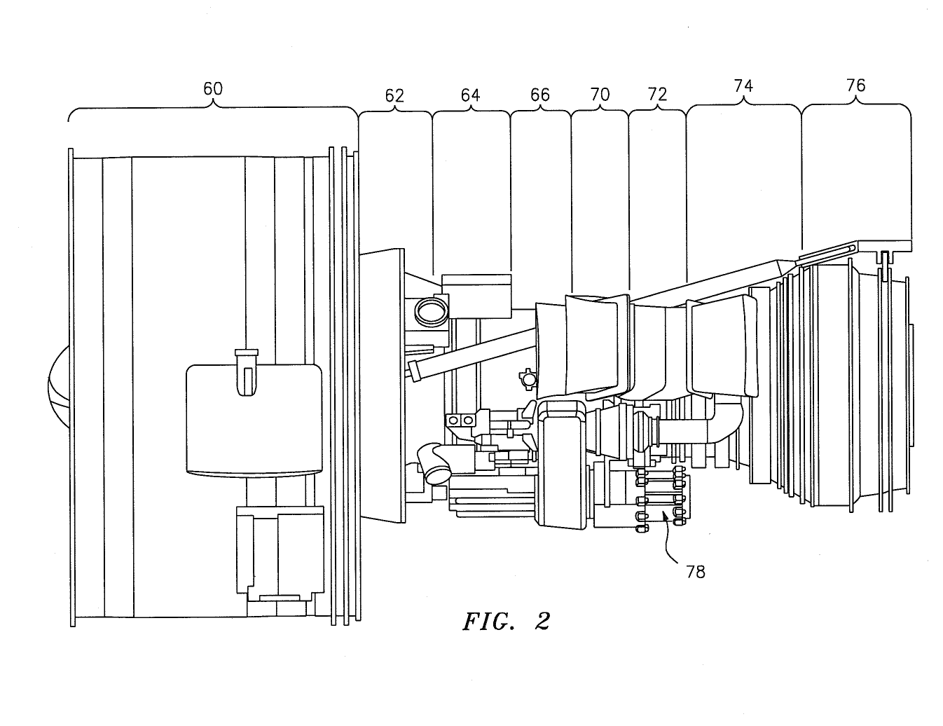

With reference to FIG. 2, the engine case assembly 36 generally includes a multiple of cases or modules to include a fan case 60, an intermediate case 62, a Low Pressure Compressor (LPC) case 64, a High Pressure Compressor (HPC) case 66, a diffuser case 68, a High Pressure Turbine (HPT) case 70, a mid-turbine frame (MTF) case 72, a Low Pressure Turbine (LPT) case 74, and a Turbine Exhaust case (TEC) 76. It should be understood that additional or alternative cases may be utilized to form the engine case assembly 36. It should also be understood that the order of assembly may not necessarily follow the disclosed description. That is, the cases 60-76 may be assembled or disassembled for maintenance at any interface and in various orders.

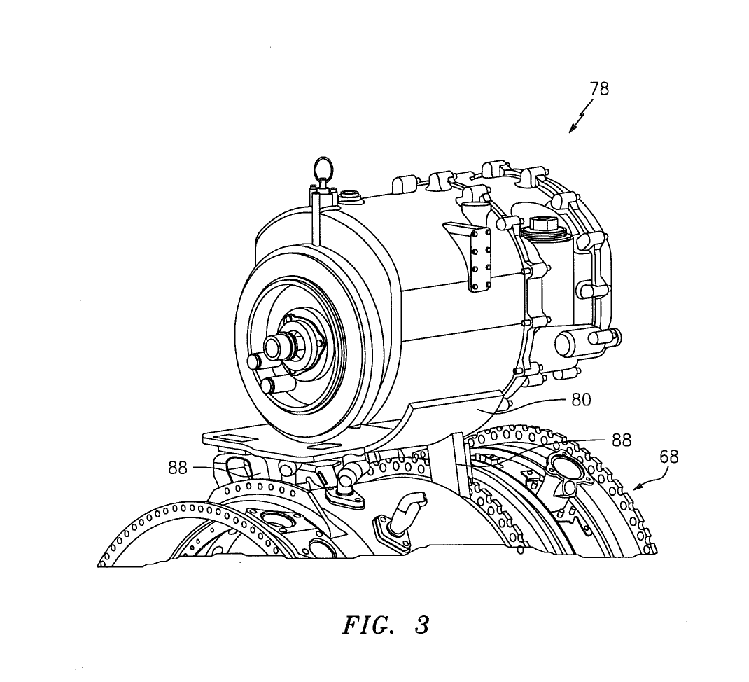

With reference to FIG. 3, an external component 78 such as an Integrated Drive Generator (IDG) is mounted to one or more of the fan case 60, the intermediate case 62, the LPC case 64, the HPC case 66, the diffuser case 68, the HPT case 70, the MTF case 72, the LPT case 74, and the TEC 76 here shown as the diffuser case 68. A flexible heat shield 80 is mounted between the external component 78 and the diffuser case 68. It should be understood that any external component mounted to the engine case assembly 36 will benefit herefrom.

The flexible heat shield 80 is mounted to the diffuser case 68 through a multiple of bosses 88 to interpose the flexible heat shield 80 between the external component 78 and the diffuser case 68. The multiple of bosses 88 provide a spaced relationship for the external component 78 from the diffuser case 68 as well as accommodate the shape of the external component 78 relative to the diffuser case 68. That is, the shape of the external component 78 is accommodated by the multiple of bosses 88. The multiple of bosses 88 may additionally be utilized to mount the external component 78. Alternatively, the external component 78 may be mounted with separate structures.

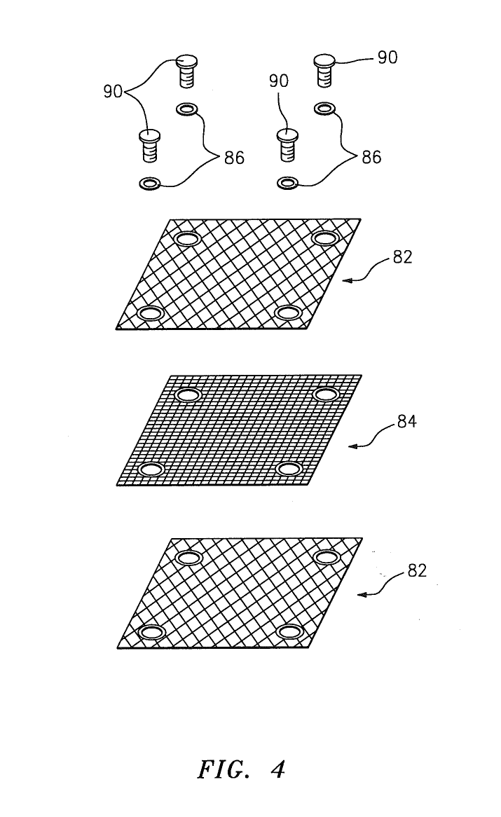

The flexible heat shield 80 generally includes a ceramic fiber layer 82, a support layer 84 and a multiple of grommets 86 which attach the ceramic fiber layer 82 and the support layer 84 (FIG. 4). It should be appreciated that any number of ceramic fiber layers 82 and flexible support layers 84 may be utilized. The heat flow through the flexible heat shield 80 is composed of the temperature gradient, the K factor of the insulation composite and the emissivity of the ceramic composite material. Here, one objective is to prevent thermal radiation above a predefined level effecting the external component 78. It should be appreciated that the ceramic fiber layer 82 may be manufactured of heat resistant materials such as aluminum oxide, silicon oxide, bromine oxide or other heat resistant material.

In one disclosed, non-limiting embodiment, the ceramic fiber layers 82 are Nextel ceramic 312 woven sheet. For example, five (5) layers of the Nextel ceramic 312 woven sheet shields radiation up to 96.5% and ten (10) layers shield up to 97.8% of radiation emitted from the engine core. The ceramic fiber layers 82 eliminate thermal self-emission typical of metal heat shields. This is due in part to the Nextel properties such as Al2O3, SiO2, and B2O3 at varying percentages. Because B2O3 is present, the composite has both a crystalline and glassy phase. The glassy phase permits the fiber to retain strength after exposure to high temperatures as it slows the growth of the crystalline phases that otherwise may weaken the fiber.

With reference to FIG. 4, the support layer 84 may include a wire mesh, woven metal mesh, thin metal sheet or other flexible shape-holding material that will facilitate shape-holding to the flexible heat shield 80. That is, the support layer 84 may be manufactured of a flexible material that permits shaping of the ceramic fiber layer 82 when sandwiched therewith. Alternatively, the support layer 84 may be manufactured of a material which is initially flexible then relatively rigid after manufacture. The support layer 84 facilitates a desired spacing from the diffuser case 68 and external component 78 as well as accommodates potential geometrical changes to the external component 78 without the necessity of a new conventional metal heat shield. That is, if a modified, different model or upgraded external component is to be mounted, the flexible heat shield 80 is readily flexed to accommodate the different shape. The support layer 84 also minimizes potential wear and tear of the flexible heat shield 80.

It should be appreciated that the ceramic fiber layer 82 and the flexible support layers 84 may be folded or otherwise interleaved to provide various sandwich structures such as the support layer 84 folded into the ceramic fiber layers 82 (FIG. 5).

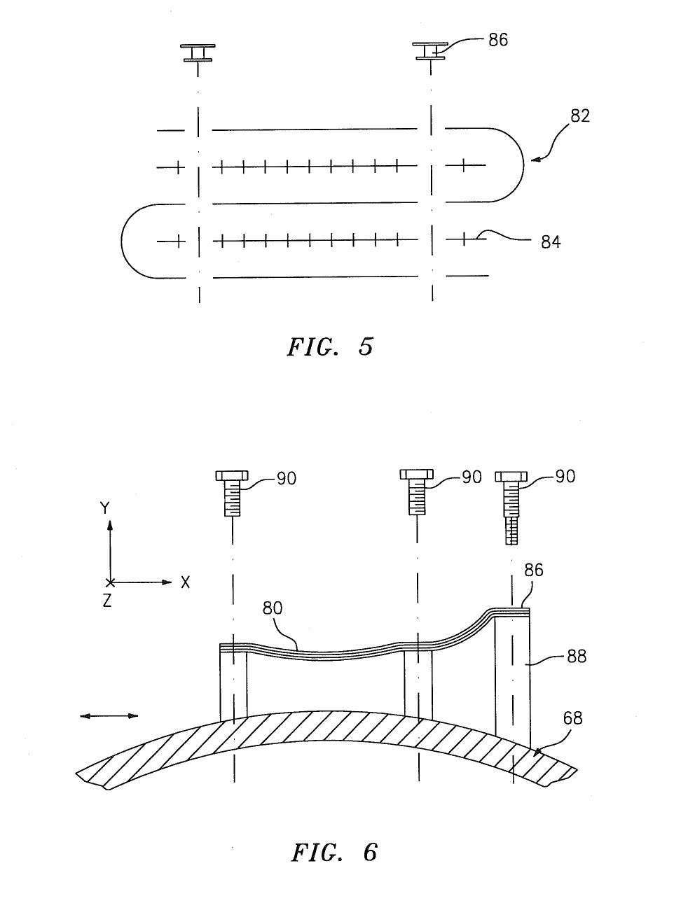

With reference to FIG. 6, the grommets 86 may be manufactured of metal alloys, or ceramic matrix composites to assemble the ceramic fiber layers 82 and the flexible support layers 84. That is, the grommets 86 may be utilized to sandwich and retain together the ceramic fiber layers 82 and the flexible support layers 84. It should be appreciated that other attachment provisions such as adhesive may alternatively or additionally be utilized.

The grommets 86 are located in coordination with the bosses 88 which receive fasteners 90 therethrough for attachment into the bosses 88. The bosses 88 may include J-Blades which are brackets welded to a tube to support a harness or some other dampening material. The fasteners 90 may include rivets, bolts or others which retain and shape the flexible heat shield 80.

The bosses 88 define an X, Y and Z position for each associated grommet 86 such that a shape of the flexible heat shield 80 is defined thereby. That is, rather than a conventional specifically formed metal heat shield, the bosses 88 are arranged as desired and the flexible heat shield 80 is formed thereto. The flexible heat shield 80 thereby readily accommodates a change to, or even a different, external component 78.

The flexible heat shield 80 is lightweight, cost effective, and durable with the heretofore unavailable advantage of being molded to accommodate potential geometric changes to the accessory component. The flexible heat shield 80 also eliminates specific or close tolerance bracketry and other mounts with relatively uncomplicated bosses 88. In the disclosed non-limiting embodiment, the flexible heat shield 80 for an IDG results in a weight reduction of about five hundred percent (500%).

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A flexible heat shield comprising:
a ceramic fiber layer; and
a support layer attached to said ceramic fiber layer.

2. The flexible heat shield as recited in claim 1, wherein said ceramic fiber layer includes aluminum oxide, silicon oxide, or bromine oxide.

3. The flexible heat shield as recited in claim 1, wherein said support layer is a wire mesh.

4. The flexible heat shield as recited in claim 1, wherein said support layer is a sheet metal.

5. The flexible heat shield as recited in claim 1, wherein said ceramic fiber layer and said support layer include a multiple of metal grommets.

6. The flexible heat shield as recited in claim 1, further comprising a multiple of grommets which attach said ceramic fiber layer and said support layer together.

7. The flexible heat shield as recited in claim 6, further comprising a multiple of ceramic fiber layers.

8. The flexible heat shield as recited in claim 6, further comprising a multiple of ceramic fiber layers which sandwich said support layer therebetween.

9. The flexible heat shield as recited in claim 6, wherein said ceramic fiber layer is folded over said support layer therebetween.

10. A gas turbine engine comprising:
an engine case; and
a flexible heat shield mounted to said engine case.

11. The gas turbine engine as recited in claim 10, further comprising a multiple of bosses which extend from said engine case, said flexible heat shield mounted to said multiple of bosses.

12. The gas turbine engine as recited in claim 11, wherein each of said multiple of bosses define an X, Y, Z location for said flexible heat shield.

13. The gas turbine engine as recited in claim 11, further comprising a multiple of metal grommets which attach said flexible heat shield to said multiple of bosses.

14. The gas turbine engine as recited in claim 13, further comprising a fastener that extends through each of said metal grommets and into a respective one of said multiple of bosses.

15. The gas turbine engine as recited in claim 14, wherein said multiple of bosses are J-Blades.

16. The gas turbine engine as recited in claim 10, wherein said flexible heat shield includes: a ceramic fiber layer; and a support layer attached to said ceramic fiber layer.

17. The gas turbine engine as recited in claim 16, further comprising a multiple of grommets which attach said ceramic fiber layer and said support layer together.

18. The gas turbine engine as recited in claim 16, further comprising a multiple of ceramic fiber layers.

19. The gas turbine engine as recited in claim 16, further comprising a multiple of ceramic fiber layers which sandwich said support layer therebetween.

20. The gas turbine engine as recited in claim 16, wherein said ceramic fiber layer is folded over said support layer therebetween.
